(19) United States
(12) Patent Application Publication
(10) Pub. No.: US 2022/0024153 A1
(43) Pub. Date: Jan. 27, 2022

(54) STRUCTURAL BODY MANUFACTURING METHOD AND STRUCTURAL BODY

(71) Applicant: GRAPHITE DESIGN INC., Chichibu-shi (JP)

(72) Inventors: Keizo MATSUMOTO, Chichibu-shi (JP); Yuichiro MATSUZAKI, Chichibu-shi (JP); Ryuta TSUJIMOTO, Chichibu-shi (JP)

(21) Appl. No.: 16/938,843

(22) Filed: Jul. 24, 2020

(51) Int. Cl. B29C 70/32; B29C 70/34; B29C 70/54

(52) U.S. Cl. CPC B29C 70/32; B29K 2101/10; B29C 70/54; B29C 70/345

(57) ABSTRACT

A structural body manufacturing method includes a first step of forming a cylindrical laminate body LM by winding a plurality of sheets including reinforcing fibers and an uncured thermosetting resin around a mandrel MD, a second step of compressing an entire circumference of the laminate body with a tape TP, a third step of heating the laminate body to a state prior to when the thermosetting resin is completely cured, a fourth step of extracting the mandrel from the laminate body, a fifth step of placing the laminate body around which the tape is wound in a molding die UD, LD, pressurizing the laminate body, and heating the laminate body until the thermosetting resin is completely cured, and a sixth step of removing the laminate body from the molding die and peeling off the tape.

### TECHNICAL FIELD

The present invention relates to a structural body manufacturing method and a structural body.

### BACKGROUND OF THE INVENTION

From the viewpoint of component weight reduction, there have been attempts to replace metallic structural bodies with structural bodies made of Fiber Reinforced Plastics (FRP), in which reinforcing fibers such as carbon fibers are strengthened by resins. Here, as an example of a FRP-made structural body, the hollow cylindrical members already used for bicycle frames or the like are known.

However, since the frames of bicycles are originally made of metal round pipes joined together, it is relatively easy to replace them with FRP-made hollow cylindrical members, with the exception of difficulties at the join portions or the like. On the other hand, with regard to the structural bodies used in vehicles, since the installation space is limited, there is a problem in that it is difficult to use hollow cylindrical members as-is. Accordingly, in order to allow for a wider range of use as structural bodies, there is demand to form FRP-made structural bodies into plate-shaped or non-circular hollow cross-sectional shapes (for example, rectangular cylindrical shapes).

As one proposal for forming a plate-shaped FRP-made structural body, there is a method of laminating a plurality of prepregs on a mold die, and completely curing them. A prepreg is a sheet-shaped reinforced plastic molded article in which a thermosetting resin such as epoxy is uniformly impregnated into a reinforcing fiber and heated or dried to a semi-cured state.

However, in a FRP-made structural body formed in this way, there are problems in that distortion is likely to occur in the curing process, and an accurate, flat plate shape cannot be obtained.

In addition, if torsional deformation is repeatedly applied to both ends of a plate-shaped FRP-made structural body formed by laminating as described above, relative movement occurs between the upper surface side sheet and the lower surface side sheet. For this reason, there is a problem that the adhesive of the sheets peels off at both edges in the central width direction of the structural body, the fibers tend to peel off, and the strength is decreased.

On the other hand, as one proposal for forming an FRP-made structural body having a non-circular hollow cross-sectional shape, there is a method in which a flexible hollow core having a laminated prepreg or the like disposed around its outer circumference is disposed within the mold, and the hollow core is expanded by pressurization while being heated, by which the outer surface of the prepreg is formed to conform to the mold. However, when molding is performed by such a manufacturing method, there is a risk that wrinkles, voids, and resin rich caused by reinforcing fibers that cannot conform to the shape change in accordance with the mold may occur when the wall thickness of the prepreg changes during the pressurizing and heating process at the time of molding. As a result, the product quality and the product strength of the FRP-made structural bodies is decreased.

With respect to this problem, Patent Document 1 discloses a technique for forming an FRP-made structural body having a non-circular hollow cross-sectional shape. According to the technique disclosed in Patent Document 1, a hollow core having a reinforcing fiber base material disposed on its outer circumference is disposed in a cavity of a molding die, and after the mold is clamped, a resin is injected into the molding die while pressurizing the inside of the core, whereby an FRP hollow structural body can be molded.

### CITATION LIST

### Patent Literature

[Patent Document 1] Japanese Unexamined Patent Application Publication No. 2006-159457

### SUMMARY OF INVENTION

### Technical Problem

According to the technique of Patent Document 1, by injecting a resin into a molding die while pressurizing a hollow core disposed in the molding die, it is ostensibly possible to prevent problems such as wrinkles or voids from occurring in an FRP hollow structural body. However, such a technique has a problem in that large-scale equipment such as a resin flow path for injecting resin into the molding die is required, resulting in a high cost.

It is therefore an object of the present invention to provide a structural body manufacturing method and a structural body that offer high accuracy of form and strength despite being low cost.

### Means for Solving the Problems

In order to achieve the above object, a structural body manufacturing method according to the present invention includes first step of forming a cylindrical laminate body by winding a plurality of sheets and/or tapes including reinforcing fibers and an uncured thermosetting resin around a mandrel, a second step of compressing an entire circumference of the laminate body with a tape or a film; a third step of heating the laminate body to a state prior to when the thermosetting resin is completely cured; a fourth step of extracting the mandrel from the laminate body; and a fifth step of placing the laminate body around which the tape or film is wound in a molding die, pressurizing the laminate body, and heating the laminate body until the thermosetting resin is completely cured.

The structural body according to the present invention is formed from a thermosetting resin impregnated with reinforcing fibers that has a first plane and a second plane on its outer surface, wherein a normal line extending outward from the first plane and a normal line extending outward from the second plane are oriented in different directions in a cross section orthogonal to an axis of the structural body, and an intersection portion of the first plane and the second plane has a curved surface with a constant curvature or a gradual change, and the reinforcing fiber passing through the intersection portion is continuous without being broken.

The structural body according to the present invention i s formed from a thermosetting resin impregnated with reinforcing fibers and formed in a polygonal shape or a flat plate shape including at least two flat surface portions bent at an intersection portion, wherein: the intersection portion includes a curved outer surface; and the reinforcing fibers extend from one of the flat surface portions through the intersection portion to another flat portion.

The structural body according to the present invention is formed by a process including the steps of forming a cylindrical laminate body by winding a plurality of sheets and/or tapes including reinforcing fibers and an uncured thermosetting resin around a mandrel, compressing an entire circumference of the laminate body with a tape or a film, heating the laminate body to a state prior to when the thermosetting resin is completely cured, extracting the mandrel from the laminate body; and placing the laminate body around which the tape or film is wound in a molding die, pressurizing the laminate body, and heating the laminate body until the thermosetting resin is completely cured. It should be noted that, as it is difficult to directly specify the structural body according to the present invention by its structure or characteristics, the structural body itself is specified in terms of a structural body manufacturing method.

### Advantageous Effects of Invention

According to the present invention, it is possible to provide a structural body manufacturing method and a structural body that offer high accuracy of form and strength despite being low cost.

### BRIEF DESCRIPTION OF DRAWINGS

FIG. 1 is a diagram illustrating a first step of a structural body manufacturing method according to the present embodiments, and illustrates a prepreg and a mandrel in a plan view.

FIG. 2 is a diagram illustrating a second step of the structural body manufacturing method according to the present embodiments.

FIG. 3 is a diagram illustrating a third step of the structural body manufacturing method according to the present embodiments.

FIG. 4 is a diagram illustrating an example of a DSC curve for an uncured thermosetting resin, in which the vertical axis represents heat flow and the horizontal access represents temperature.

FIG. 5 is a diagram illustrating an example of a DSC curve for a completely cured thermosetting resin, in which the vertical axis represents heat flow and the horizontal axis represents temperature.

FIG. 6 is a diagram illustrating a fourth step of the structural body manufacturing method according to the present embodiments, and illustrates a state in which the mandrel is extracted from the laminate body.

FIG. 7 is a diagram illustrating a portion of a fifth step of the structural body manufacturing method according to the present embodiments, and illustrates a state in which a rubber body is inserted into the laminate body.

FIG. 8 is a cross-sectional diagram illustrating a portion of a fifth step of the structural body manufacturing method according to the present embodiments, and illustrates a state prior to mold clamping as viewed in the axial direction of the laminate body.

FIG. 9 is a cross-sectional diagram illustrating a portion of a fifth step of the structural body manufacturing method according to the present embodiments, and illustrates a state in which the mold is clamped and heated.

FIG. 10 is a perspective view of the structural body manufactured by the manufacturing method according to the present embodiments.

FIG. 11 is a cross-sectional diagram illustrating a state of attaching a mounting member to the structural body.

FIG. 12 is a perspective view illustrating the structural body with the mounting member attached, in which a portion of the laminate body is shown transparently.

FIG. 13 is a cross-sectional diagram illustrating a portion of a fifth step of the structural body manufacturing method according to another embodiment, and illustrates a state prior to mold clamping as viewed in the axial direction of the laminate body.

FIG. 14 is a cross-sectional diagram illustrating a portion of a fifth step of the structural body manufacturing method according to another embodiment, and illustrates a state in which the mold is clamped and heated.

FIG. 15 is a perspective view of the structural body manufactured by the manufacturing method according to another embodiment.

FIG. 16 is a plan view of the structural body manufactured by the manufacturing method according to another embodiment, and is shown together with reinforcing fibers.

FIG. 17 is a cross-sectional diagram of the structural body according to a modified example.

FIG. 18 is a cross-sectional diagram of the structural body according to a modified example.

FIG. 19 is a cross-sectional diagram of the structural body according to yet another modified example.

FIG. 20 is a perspective view of the structural body according to yet another modified example.

### DESCRIPTION OF EMBODIMENT(S)

Hereinafter, the embodiments according to the present invention will be described with reference to the accompanying drawings.

It should be noted that, in the present specification, the “reinforcing fibers” are preferably organic fibers represented by carbon fibers, glass fibers, or aramid fibers, silicon carbide fibers, metal fibers, or the like. In addition, it is preferable that the “thermosetting resin” is an epoxy resins, a polyester resin, a vinyl ester resin, a phenol resin, a urethane resin, a polyimide resin, or the like.

The “cylindrical laminate body” can be formed by using a sheet winding manufacturing method to wind a prepreg sheet in which reinforcing fibers have been impregnated with a thermosetting resin and that has been heated or dried to a semi-cured state, or can be formed by using a tape winding method to wind a prepreg tape.

Alternatively, the cylindrical laminate can be formed by winding using a filament winding method in which a roving fiber is wound while being impregnated with resin. However, the sheet winding method and the tape winding method are more preferable because it is possible to use a stable prepreg in which the ratio of the resin and the reinforcing fiber are controlled.

As the prepreg, Torayca (registered trademark) manufactured by Toray Corporation can be suitably used, for example.

The material of the “mandrel” may be any of a metal, a resin, ceramic, or the like, but from the standpoint of cost and durability, it is preferable to use metal. In addition, the shape of the mandrel is preferably a solid cylinder or a hollow cylinder, and may be a divisible shape instead of a single shape.

In the present specification, the “tape or film” refers to a thin-walled member of any material. However, from the viewpoint of ease of use, it is preferable to use tape. The tape may be made of resin, metal, or any material, but it is preferable to use a resin having good workability. In addition, when a resin tape is used, any of polypropylene, polyethylene, polyester, cellophane, Teflon (registered trademark), or polyimide may be used, but due to its good balance of tape properties, polypropylene and polyester are preferably used.

### First Embodiment

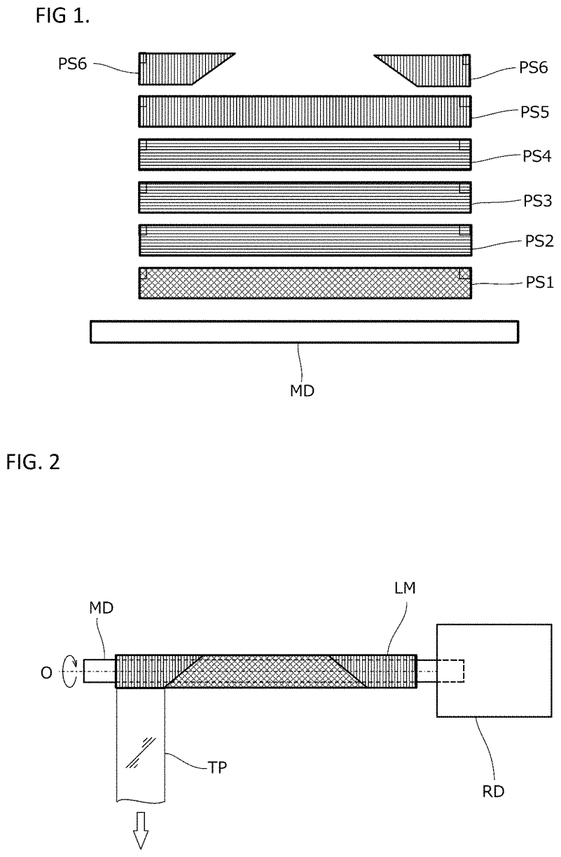

The structural body manufacturing method according to the first embodiment will be described. FIG. 1 is a diagram schematically illustrating a first step. As illustrated in FIG. 1, a mandrel MD and various prepreg sheets PS1˜PS6 are prepared.

The outer diameter of the mandrel MD is set to be slightly smaller with respect to the outer circumferential length of the structural body to be finally formed, in consideration of the thickness of the laminate wound on the outside. That is, it is desirable that the outer diameter in a state in which a plurality of prepreg sheets are wound around the mandrel MD substantially matches the design value of the outer peripheral length of the structure to be finally formed.

With regard to the prepreg sheets PS1˜PS6, here, sheets in which carbon fibers are impregnated into a raw material of an epoxy resin are used. In each prepreg sheet, the carbon fibers are oriented with regularity, and the solid lines in FIG. 1 illustrate the orientation direction of the carbon fibers. Hereinafter, the orientation direction of the carbon fibers is referred to as a state in which the prepreg sheet is expanded.

### (First Step)

A first step of the present manufacturing method will be described. The prepreg sheet PS1 is a single prepreg sheet obtained by laminating a sheet in which the orientation direction of the carbon fibers is +45 degrees with respect to the axis of the mandrel MD and a −45 degree sheet in two layers and bonding them together, and has the effect of resisting the torsional stress received by the structural body. The prepreg sheet PS1 is wound around the outer circumference of a mandrel MD subjected to a releasing treatment on its outer circumference, as necessary.

In each of the prepreg sheets PS2, PS3 and PS4, the orientation directions of the carbon fibers are parallel to the axis of the mandrel MD, which has a function of resisting the tensile stresses received by the structural body. The prepreg sheets PS2, PS3 and PS4 are wound sequentially on the prepreg sheet PS1.

In the prepreg sheet PS5, the orientation directions of the carbon fibers are perpendicular to the axis of the mandrel MD, which has a function of resisting expansion when the structural body is subjected to compressive stress. The prepreg sheet PS5 is wound around the prepreg sheet PS4.

The pair of prepreg sheets PS6 have a trapezoidal shape in which the orientation directions of the carbon fibers are perpendicular to the axes of the mandrels MDs. The prepreg sheet PS6 is wound around both ends of the prepreg sheet PS5.

In the structural body of the present embodiment, since a mounting member (to be described later) can be attached to both end portions thereof, by winding the outermost prepreg sheet PS6 around both end portions only, a reinforcing effect can be achieved. The number of prepreg sheets and the orientation direction of the carbon fibers can be appropriately changed in accordance with the desired mechanical strength of the structural body.

In this manner, a cylindrical laminate body LM (FIG. 2) is formed by winding a plurality of prepreg sheets on the mandrel MD.

### (Second Step)

A second step of the present manufacturing method will be described. FIG. 2 is a diagram schematically illustrating the second step. In FIG. 2, one end of the mandrel MD around which the laminate body LM is wound is connected to a rotary drive body RD such as a motor rotary shaft, and one end of a thin tape (here, chosen to be transparent) TP is attached to the outer circumference of the laminate body LM.

From such a state, the mandrel MD is rotated together with the rotary drive body RD, and the tape TP is wound around the outer circumference of the laminate body LM while applying a predetermined tension. The predetermined tension varies depending on conditions such as the outer diameter of the laminate body LM, but is preferably in the range of 1 to 5 kgf. As a result, by compressing and pressurizing the laminated prepreg sheets PS1˜PS6, it is possible to eliminate gaps between the prepreg sheets and the like and to increase the density of the laminate body LM.

Further, by moving the tape TP relatively along the direction of the axis O of the mandrel MD, the tape TP is wound over the entire direction of the axis O of the laminate body LM to form a thin layer having a substantially uniform thickness.

However, the means for pressurizing the laminate body LM wound on the mandrel MD is not limited to tape. For example, a tube made of a heat shrinkable film or the like may be disposed around the laminate body LM, and the heat shrinkable film may be shrunk by heating to compress the laminate body LM.

Alternatively, a rubber tape or a tube made of a rubber film (a rubber tube) may be disposed around the laminate body LM, and the laminate body LM can be compressed by its elastic force. As a result, the rotary drive body for rotating the mandrel MD becomes unnecessary, and the cost of equipment is reduced.

### (Third Step)

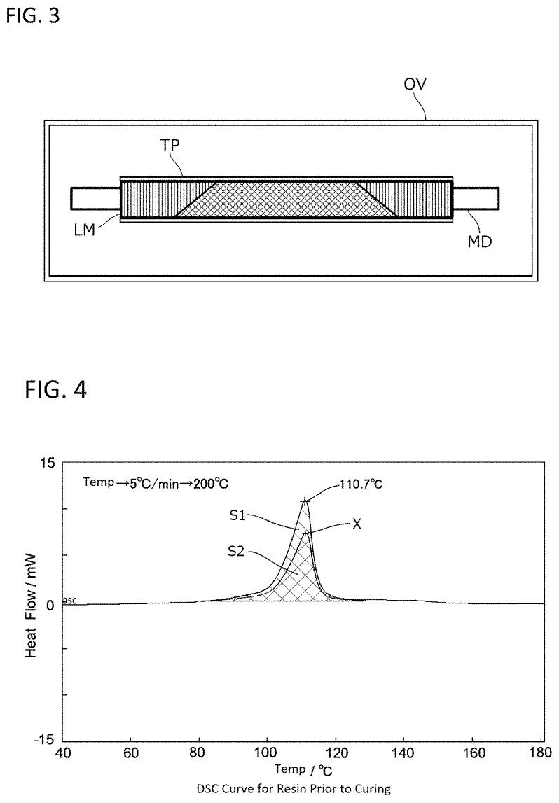

A third step of the present manufacturing method will be described. FIG. 3 is a diagram schematically illustrating the third step. A laminate body LM around which the tape TP is wound is placed in an oven OV together with the mandrel MD. The laminate body LM is heated in the oven OV to a state prior to when the resin of the prepreg sheets of the laminate body LM is completely cured. More specifically, the laminate body LM is heated such that the level of curing of the thermosetting resin of the laminate body LM is 30 to 90%.

Here, the level of curing of the thermosetting resin will be described. For example, when an uncured epoxy resin is heated at a rate of 5° C./min from room temperature to 200° C., and the heat flow (exothermic or endothermic) is measured using differential scanning calorimetry (DSC), it is found that a phenomenon peculiar to thermosetting resins occurs.

Specifically, as in the DSC curve illustrated in FIG. 4, rapid heat generation occurs starting around 103° C., the peak in heat generation occurs at 110.7° C., and thereafter, the heat generation decreases rapidly. This heat generation represents that polymerization (curing) resulting from heating epoxy resin to an elevated temperature has occurred. Here, 110.7° C. is referred to as the maximum exothermic temperature of the epoxy resin.

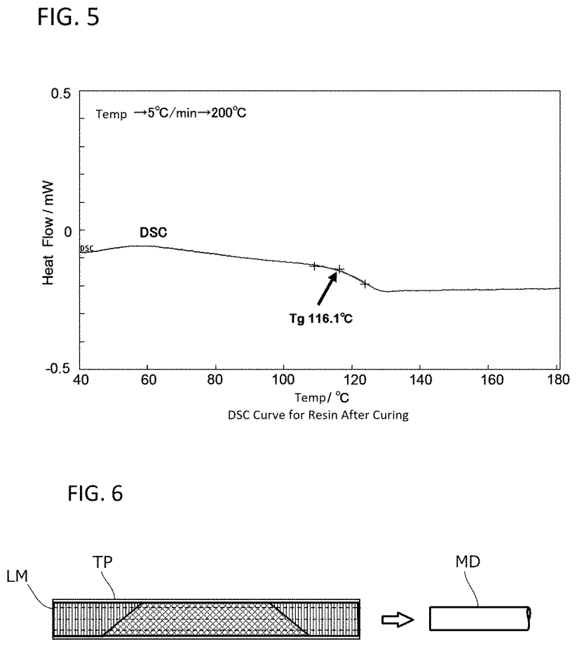

When the epoxy resin is cooled again to room temperature and heated a second time to 200° C. at a rate of 5° C./min, as in the DSC curve illustrated in FIG. 5, the exothermic peak does not appear, and instead, an endothermic reaction occurs, and it can be seen that a glass transition occurs at 116.1° C. This is a phenomenon that occurs because the epoxy resin is already completely cured. (“Survey of Curing Temperature and Glass-Transition Temperature of Epoxy-Resins,” MST Technical Document: No. C0220, Date of Publication: Oct. 20, 2011, Foundation: Material Foundation for Science and Technology)

On the other hand, if the heating is interrupted before the epoxy resin is completely cured, the exothermic peak becomes X° C., below 110.7° C. (FIG. 4). This indicates that there is the potential for further polymerization of the epoxy resin; that is, that the epoxy resin is in a state prior to complete curing. In other words, when heating the thermosetting resin, by measuring the exothermic peak as necessary and interrupting the heating when the temperature becomes X° C., below the maximum exothermic temperature, it is possible to maintain the state prior to complete curing of the thermosetting resin.

In FIG. 4, when the area (referred to as the exothermic peak area) enclosed by the DSC curve at the time of complete curing and the baseline BS is set as S1, and the area enclosed by the DSC curve with an exothermic peak of X° C. and the baseline BS is set as S2, (S2/S1)×100% is defined as the level of curing of the thermosetting resin.

Taking advantage of the thermal characteristics of this thermosetting resin, the present inventors have found that the formability of the laminate body LM is improved by interrupting the heating of the laminate body LM at a curing level of 30-90%, for example, before the thermosetting resin is completely cured. The exothermic peak X° C. corresponding to the curing level of 30 to 90% can be obtained by experiments and by simulation. The effect of improving the formability of the laminate body LM will be described later in connection with the fifth step.

### (Fourth Step)

A fourth step of the present manufacturing method will be described. FIG. 6 is a diagram schematically illustrating the fourth step. The laminate body LM on which the tape TP was wound is taken out of the oven OV, and the mandrel MD is pulled out as illustrated in FIG. 6. Since the tape TP is wound around the outer circumference of the laminate body LM with a predetermined tension, and the thermosetting resin of the laminate body LM is heated to a level of curing of 30% or more in the third step, the laminate body LM has rigidity capable of maintaining a cylindrical shape even when the mandrel MD is pulled out. This cylindrical shape is referred to as a preform body.

The unheated laminate body LM needs to be stored in a refrigerator or a freezer in order to prevent degradation of the resin material. On the other hand, with regard to the preform body formed through the fourth step, the level of curing of the resin material has been modified, and there is almost no deterioration of the resin material even when stored at room temperature. Accordingly, by mass-producing preform bodies and storing them, it becomes possible to supply the product in response to sudden demand.

In addition, since a plurality of types of structural bodies can be formed from one type of preform body, manufacturing costs can be reduced.

### (Fifth Step)

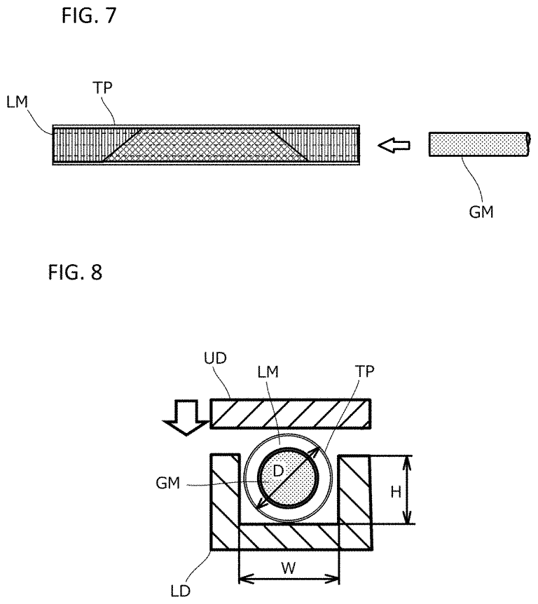

A fifth step of the present manufacturing method will be described. FIG. 7 to FIG. 9 are diagrams schematically illustrating the fifth step. First, as illustrated in FIG. 7, a cylindrical rubber body GM is inserted into the laminate body LM from which the mandrel MD was pulled out. The cylindrical rubber body GM, which has substantially the same diameter as the mandrel MD, has a characteristic of expanding when heated.

Furthermore, as illustrated in FIG. 8, the laminate body LM into which the rubber body GM was inserted is disposed between a plate-shaped upper mold UD and a trough-shaped lower mold LD. The upper mold UD and the lower mold LD constitute a molding die.

Here, when the width of the trough bottom surface in the lower mold LD is set as W, the height of the trough inner wall is set to H, and the outer diameter of the laminate body LM wound with tape TP is set to D, then πD≈2 (W+H) , the inner circumferential length of the mold, and the outer circumferential length of the final structural body can be made substantially equal to each other, whereby a structural body having a consistent shape can be obtained.

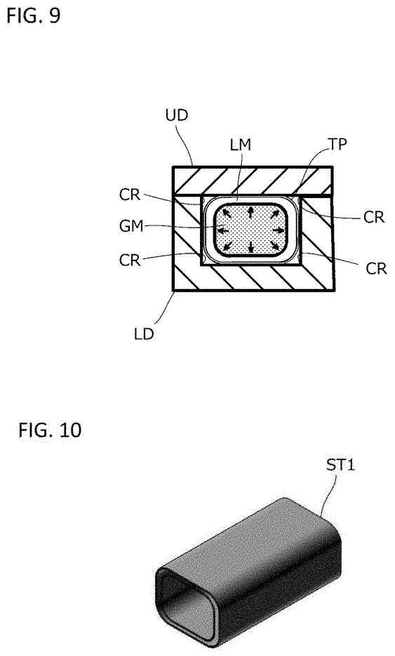

Thereafter, as illustrated in FIG. 9, the upper mold UD and the lower mold LD are brought relatively close to each other and mold clamping is performed. At this time, since the thermosetting resin of the laminate body LM has been heated to a level of curing of 90% or less in the previous third step, the laminate body LM can be deformed so as to conform to the inner wall shape formed by the upper mold UD and the lower mold LD. On the other hand, since the tape TP was wound with a predetermined tension, the laminate body LM is not crushed by the pressure of the upper mold UD and the lower mold LD.

Furthermore, by heating the inside of the upper mold UD and the lower mold LD using a heater (not illustrated in the Figures), the rubber body GM expands, thereby increasing the internal pressure of the laminate body LM. As a result, the laminate body LM is pressed toward the inner wall surface of the upper mold UD and the lower mold LD, and in particular the gap between the inner wall-shaped corner portion CR of the upper mold UD and the lower mold LD and the laminate body LM is closed, such that it is possible to accurately deform the laminate body LM into a rectangular cylindrical shape. In addition, by heating the laminate body LM, it can be completely cured.

At this time, since a tape TP with a high slidability is wound around the laminate body LM subjected to internal pressure, even in cases in which a relative displacement occurs between the outer surface of the laminate body LM and the inner wall surface of the molding die as the rubber body GM expands, sliding can occur between the two with almost no resistance. As a result, the mold familiarity of the laminate body LM is improved, and a consistent product shape can be obtained. In addition, even if a gap occurs between the laminate body LM and the upper mold UD or the lower mold LD, since the tape TP wound around the outer circumference of the laminate body LM can receive the internal pressure of the rubber body GM, it is possible to effectively suppress defects such as wrinkles, voids and resin rich of the laminate body LM, which often occur particularly in the vicinity of the corner portion CR.

On the other hand, by improving the mold familiarity of the laminate body LM, since it is possible to reduce the pressure of the molding die while reducing the strength and rigidity of the mold, the degree of freedom in selection of a usable mold material can be expanded. In addition, since the equipment for driving the molding die can also be simplified, a reduction in equipment cost can be achieved.

In addition, due to the shape retaining function of the tape TP, the intersection portion of the side surface (the first surface) and the upper and lower surfaces (a second surface with a normal line having a direction that is different from the first surface) of the laminate body LM formed by being strongly pressed against the right angle corner CR has a curved surface with a curvature that is constant or that gradually changes (that is, no edge is formed at the intersection portion). In addition, since the reinforcing fibers at the intersection portion bend without being broken (the continuity of the fibers is maintained), the strength of the structural body can be secured.

### (Sixth Step)

Thereafter, the heating is interrupted, the upper mold UD and the lower mold LD are separated from each other, and each laminate body LM that has been formed into a cylindrical shape is taken out. In addition, by peeling the tapes TP from the laminate body LM, the structural body ST1 illustrated in part in FIG. 10 is completed.

It should be noted that, instead of the rubber body GM, an air bag which is inflated by injecting air or the like may also be used.

### MODIFIED EXAMPLE

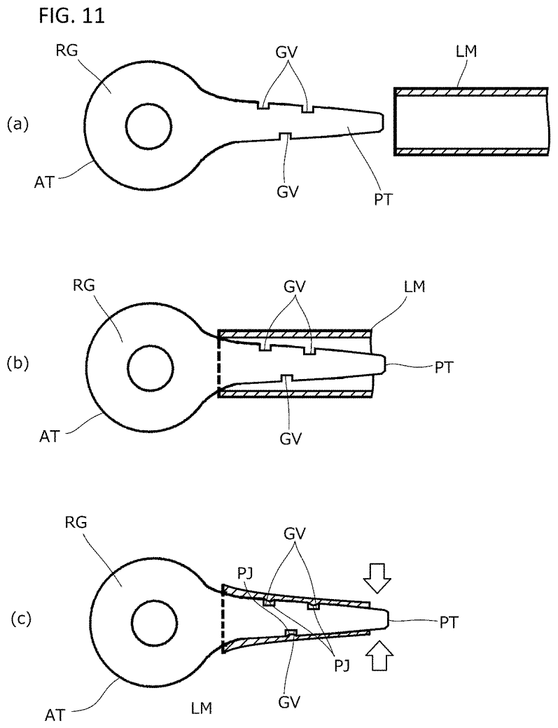

By attaching a mounting member to the structural body ST1 formed as described above, it is possible to connect the structural body ST1 to other components. FIG. 11 is a diagram schematically illustrating a fifth step according to a modified example. Here, a metal mounting member AT or the like is prepared in advance.

The mounting member AT has a shape in which a tapered plate portion PT is integrally joined to a ring-shaped head RG. Grooves GV are formed in the upper and lower surfaces of the plate portions PT, respectively.

Referring to FIG. 7, when the laminate body LM is disposed between the upper mold UD and the lower mold LD without interposing a rubber body therein, the plate portions PT of the mounting member AT are opposed at both ends (FIG. 11(a)), and the plate portions PT are inserted into the laminate body LM (FIG. 11(b)).

Thereafter, as illustrated in FIG. 9, by performing mold clamping of the upper mold and the lower mold, when the laminate body LM is brought into close contact with the plate portion PT while being heated, a portion of the inner circumferential surface of the still relatively soft laminate body LM becomes the protrusion PJ, enters the groove GV of the plate portion PT, and solidifies in this state (FIG. 11(c)).

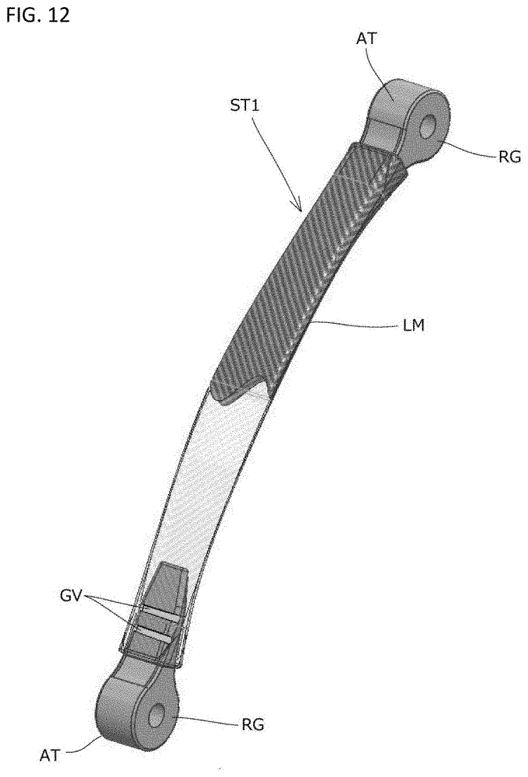

In this way, the mounting member AT is prevented from coming out with respect to the laminate body LM. Thereafter, the tape is peeled off in the sixth step, whereby a beam-shaped structural body ST1 as illustrated in FIG. 12 can be obtained.

The structural body ST1 illustrated in FIG. 12 can be installed by bolting the head RG of the mounting member AT and another component (not illustrated in the Figures).

### Second Embodiment

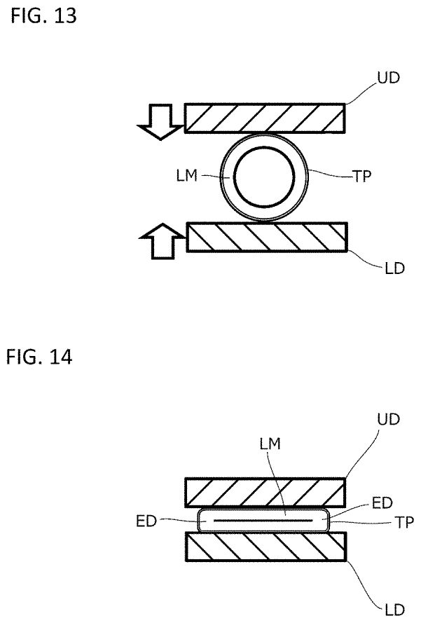

A structural body manufacturing method according to a second embodiment will be described. FIG. 13 and FIG. 14 are diagrams schematically illustrating a fifth step according to the second embodiment. In the second embodiment, the first step to the fourth step are the same as in the first embodiment. That is, use of the preform bodies formed in the first to fourth steps can be shared.

### (Fifth Step)

The laminate body LM, which is a preform body formed in the fourth step and from which the mandrel MD was pulled out, is disposed between the plate-shaped upper mold UD and the plate-shaped lower mold LD as illustrated in FIG. 13, without inserting a rubber body or the like.

Thereafter, the upper mold UD and the lower mold LD are brought relatively close to each other in a parallel state and mold clamping is performed. Since the interior of the laminate body LM has a cavity, as illustrated in FIG. 14, the laminate body LM is crushed by the lower plane of the upper mold UM and the upper plane of the lower mold LD, becomes plate-shaped, and the internal cavity is eliminated.

At this time, since the thermosetting resin of the laminate body LM was heated to a level of curing of 90% or less in the previous third step, a large deformation in which the laminate body LM is crushed into a flat plate shape is permitted.

In addition, due to the shape retaining function of the tape TP, even if the laminate body LM is crushed into a flat plate shape, the outer surface of both edges ED of the laminate body LM, which is the intersection portion of the upper surface (the first surface) and the lower surface (a second surface with a normal line having a direction that is different from the first surface) of the laminate body LM has a curved surface with a curvature that is constant or gradually changing. In other words, a normal line extending outward from the first plane and a normal line extending outward from the second plane are oriented in different directions in a cross section perpendicular to the axis of the laminate body LM. Accordingly, the appearance quality and the strength with respect to bending and twisting of the structural body can be improved. In addition, since the reinforcing fibers that pass through both edges ED can also bend without breaking (such that the continuity of the fibers is maintained), high strength can be further secured.

### (Sixth Step)

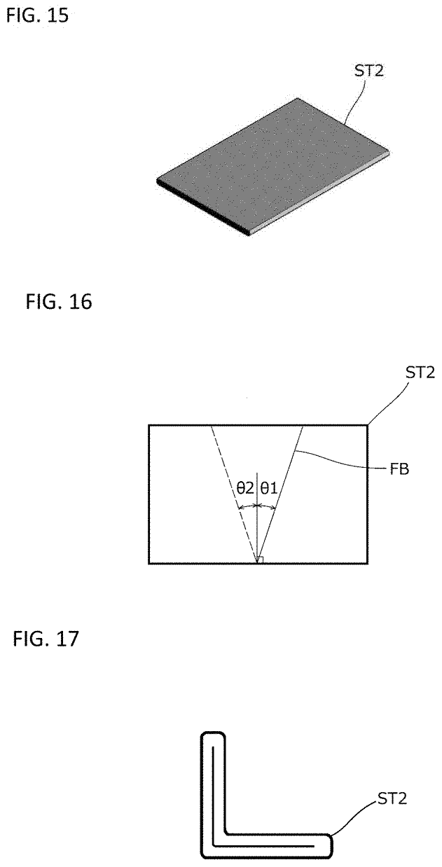

Thereafter, by separating the upper mold UD and the lower mold LD, taking out the laminate body LM which has been deformed into a plate shape, and further peeling the tape TP from the laminate body LM, a structural body ST2 as partially illustrated in FIG. 15 is completed. The structural body ST2 may be drilled in the vicinity of both ends thereof and bolted to other components.

FIG. 16 is a top view of a the structural body ST2 illustrating one continuous reinforcing fiber FB with a solid line passing through the front surface side and a dotted line passing through the back surface side. In the present embodiment, the structural body ST2 is formed by crushing a cylindrical laminate LM. Accordingly, regardless of the position where the reinforcing fibers FB spirally wound around the cylindrical laminate body LM are crushed, as illustrated in FIG. 16, the inclination angle θ1 of the reinforcing fibers FB on the front surface side and the inclination angle θ2 of the reinforcing fibers FB on the back surface side are equal due to the geometrical relationship. As a result, distortion of the structural body ST2 is suppressed, and it is possible to maintain an accurate flat plate shape. It should be noted that the location where the flat surface portion on the front surface side and the flat surface portion on the back surface side intersect is an intersection portion having a curved outer surface, and the reinforcing fibers FB extend from the flat surface portion on the front surface side to the flat surface portion on the back surface side through the intersection portion.

### MODIFIED EXAMPLES

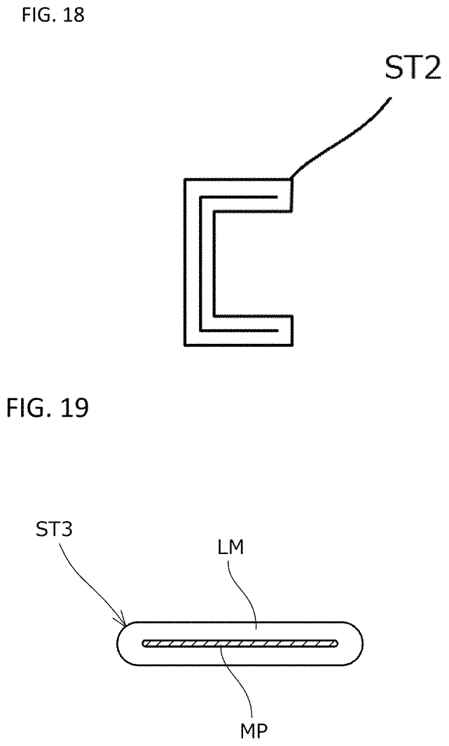

FIG. 17 and FIG. 18 are cross-sectional views illustrating modified examples of the second embodiment. By changing the shape of the molding die that crushes the cylindrical laminate body LM, as illustrated in FIG. 17, a structural body ST2 having an L-shaped cross section can be formed, or as illustrated in FIG. 18, a structural body ST2 having a C-shaped cross section can be formed.

FIG. 19 is a cross-sectional view of a structural body according to yet another modified example. The structural body ST3 according to the present modified example is formed by crushing the laminate body LM with the upper die and the lower die while inserting a metal plate, which is semi-cylindrical and of a different material, into the laminate body LM at the time of molding illustrated in FIG. 14. The laminate body LM is crushed into a flat plate shape by the mold, and at the same time, the metal plate is also flatly formed into the flat plate MP. At this time, the inner surface of the laminate body LM comes into close contact with the upper surface and the lower surface of the flat plate MP. Instead of a semi-cylindrical metal plate, a flat plate may be inserted, or a plate made of a material other than metal may be inserted.

According to the structural body ST3 according to the present modified example, even in a case when an excessive stress exceeding the allowable stress of the laminate body LM is exerted, since the flat plate FP elastically deforms, the structural body ST3 can be prevented from being immediately broken or the like.

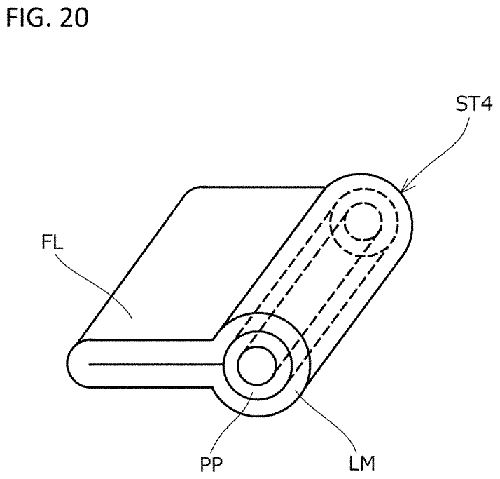

FIG. 20 is a cross-sectional view of a structural body according to yet another modified example. At the time of molding of the structural body ST4 according to the present modified example, the laminate body LM is crushed using an upper mold corresponding to the upper surface shape of the structural body ST4 and a lower mold corresponding to the lower surface shape of the laminate body LM in a state where a metal pipe PP having a smaller diameter is inserted inside the cylindrical laminate body LM. Thus, as illustrated in FIG. 20, the structural body ST4 is molded such that the inner circumference of the laminate body LM, which is cylindrical, is in close contact with the entire outer circumferential surface of the pipe PP. The pipe PP is not limited to metal.

At this time, since the inner diameter of the laminate body LM prior to molding is larger than the outer diameter of the pipe PP, the laminate body LM remains in excess after molding. Accordingly, when the inner circumference of the remaining portion of the laminate body LM is made to adhere closely and a mold is used to locally form a flat plane, the structural body ST4 has a flat portion FL that extends in the radial direction from the pipe PP. According to the present embodiment, when the pipe PP is used as, for example, a pipe through which a fluid passes, it is possible to make a hole in the flat portion FL and fasten it to the structure with bolts.

The present invention is not limited to the above embodiments. For example, in addition to the grooves, the mounting member attached to the structural body can be provided with any concave or convex shape such as holes or dimples, and the structural body can be provided with a concave or convex engaging portion that engages with a concave or convex shape.

### REFERENCE SIGNS LIST

PS1-PS6: Prepreg sheet
MD: Mandrel
TP: Tape
OV: Oven
RD: Rotary drive
GM: Rubber body
UD: Upper mold
LD: Lower mold
AT: Mounting member
ST1, ST2, ST3, ST4: Structural body

1. A structural body manufacturing method comprising:
a first step of forming a cylindrical laminate body by winding a plurality of sheets and/or tapes including reinforcing fibers and an uncured thermosetting resin around a mandrel;
a second step of compressing an entire circumference of the laminate body with a tape or a film;
a third step of heating the laminate body to a state prior to when the thermosetting resin is completely cured;
a fourth step of extracting the mandrel from the laminate body; and
a fifth step of placing the laminate body around which the tape or film is wound in a molding die, pressurizing the laminate body, and heating the laminate body until the thermosetting resin is completely cured.

2. The structural body manufacturing method according to claim 1, further comprising:
a sixth step of removing the laminate body from the molding die and peeling off the tape or film.

3. The structural body manufacturing method according to claim 1, wherein the sheet is a prepreg obtained by impregnating the reinforcing fibers with the thermosetting resin.

4. The structural body manufacturing method according to claim 1, wherein:
in the second step, a tape is wrapped around the laminate body with rotating the mandrel, while applying a predetermined tension.

5. The structural body manufacturing method according to claim 1, wherein:
in the second step, a tube made of a heat shrink film is arranged around the laminate body, and the heat shrink film is heated.

6. The structural body manufacturing method according to claim 1, wherein:
in the third step, the laminate body is heated so that the level of cure of the thermosetting resin is in a range of from 30% to 90%.

7. The structural body manufacturing method according to claim 1, wherein:
in the fifth step, pressurization is performed inside the molding die such that a space is formed inside the laminate body.

8. The structural body manufacturing method according to claim 1, wherein:
in the fifth step, pressurization is performed inside the molding die such that a space is not formed inside the laminate body.

9. A structural body formed from a thermosetting resin impregnated with reinforcing fibers that has a first plane and a second plane on its outer surface, wherein:
a normal line extending outward from the first plane and a normal line extending outward from the second plane are oriented in different directions in a cross section orthogonal to an axis of the structural body; and
an intersection portion of the first plane and the second plane has a curved surface with a constant curvature or a gradual change, and the reinforcing fibers passing through the intersection portion are continuous without being broken.

10. The structural body according to claim 9, wherein the structural body is plate-shaped and has no space inside.

11. The structural body according to claim 9, wherein the structural body is plate-shaped and contains a plate.

12. The structural body according to claim 9, wherein:
the structural body includes a tubular body of the thermosetting resin and a pipe; and
an outer circumferential surface of the pipe is in close contact with an inner circumference of the tubular body of the thermosetting resin and portions of the inner circumference of the thermosetting resin are in close contact with each other.

13. The structural body according to claim 9, wherein:
the structural body is cylindrical, is joined to a mounting member for coupling with another component, and includes therein a concave or convex engagement portion for engaging with the mounting member.

14. The structural body according to claim 9, wherein:
the thermosetting resin is in close contact with an outer surface of a separate member inserted into the cylindrical thermosetting resin.

15. A structural body formed from a thermosetting resin impregnated with reinforcing fibers and formed in a polygonal shape or a flat plate shape including at least two flat surface portions bent at an intersection portion, wherein:
the intersection portion includes a curved outer surface; and
the reinforcing fibers extend from one of the flat surface portions through the intersection portion to another flat portion.

16. A structural body formed by a process comprising the steps of:
forming a cylindrical laminate body by winding a plurality of sheets and/or tapes including reinforcing fibers and an uncured thermosetting resin around a mandrel;
compressing an entire circumference of the laminate body with a tape or a film;
heating the laminate body to a state prior to when the thermosetting resin is completely cured;
extracting the mandrel from the laminate body; and
placing the laminate body around which the tape or film is wound in a molding die, pressurizing the laminate body, and heating the laminate body until the thermosetting resin is completely cured.
